(19) United States
(12) Patent Application Publication
(10) Pub. No.: US 2026/0015496 A1
(43) Pub. Date: Jan. 15, 2026

(54) RUBBER COMPOSITION AND PNEUMATIC TIRE

(71) Applicant: Toyo Tire Corporation, Itami-shi (JP)

(72) Inventors: Akari Hashimoto, Itami-shi (JP); Takayoshi Kimura, Itami-shi (JP)

(73) Assignee: Toyo Tire Corporation, Itami-shi (JP)

(21) Appl. No.: 19/248,684

(22) Filed: Jun. 25, 2025

(30) Foreign Application Priority Data
Jul. 11, 2024 (JP) 2024-111440
Jul. 11, 2024 (JP) 2024-111445

(51) Int. Cl. C08L 9/06; B60C 1/00; B60C 11/00; C08K 3/04; C08K 5/06; C08K 5/13

(52) U.S. Cl. CPC C08L 9/06; B60C 1/0016; B60C 11/0008; C08K 3/04; C08K 5/06; C08K 5/13; B60C 2011/0025; C08K 2201/006

(57) ABSTRACT

A rubber composition comprising, per 100 parts by mass of a rubber component containing at least a diene-based rubber, 0.1 to 10 parts by mass of a compound represented by:

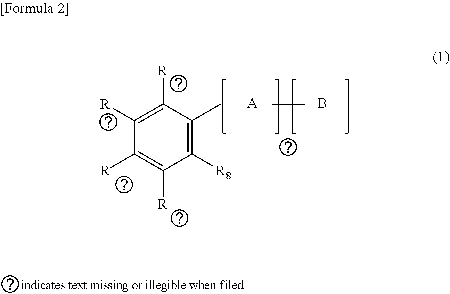

wherein at least one of R₁ to R₅ is an —OH group or an —OCH₃ group and others are —H group or hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅; and 40 to 140 parts by mass of carbon black having a nitrogen adsorption specific surface area of 140 to 250 m²/g.

### BACKGROUND OF THE INVENTION

### Field of the Invention

The present invention relates to a rubber composition and a pneumatic tire including a rubber part containing a vulcanized rubber of the rubber composition.

### Description of the Related Art

Pneumatic tires, particularly pneumatic tires for motorsports, are required to have excellent steering stability and grip performance on a wet road surface (hereinafter, also referred to as “WET grip performance”). One of the methods for improving the former is to increase the rigidity of a vulcanized rubber even at a high temperature (increase the hardness), and one of the methods for improving the latter is to increase tan δ, particularly tan δ at 0° C. (tan δ (0° C.)), of the vulcanized rubber.

Incidentally, Patent Document 1 below describes a rubber composition containing a predetermined amount of a specific compound per 100 parts by mass of the total amount of the rubber component for the purpose of improving heat aging resistance of a vulcanized rubber.

### PRIOR ART DOCUMENT

### Patent Document

Patent Document 1: JP-A-2023-089553

### SUMMARY OF THE INVENTION

The vulcanized rubber of the rubber composition described in Patent Document 1 is excellent in heat aging resistance, but as a result of intensive studies by the present inventors, it has been found that there is room for further improvement in terms of steering stability and WET grip performance in order to use the vulcanized rubber as a rubber part of a pneumatic tire, particularly a pneumatic tire for motorsports.

In view of the above circumstances, it is an object of the present invention to provide a rubber composition as a raw material of a vulcanized rubber excellent in steering stability and WET grip performance, when used as a rubber part of a pneumatic tire, particularly a pneumatic tire for motorsports.

Further, an object of the present invention is to provide a pneumatic tire and a pneumatic tire for motorsports which are excellent in steering stability and WET grip performance.

The above object can be achieved by the present invention as described below. Specifically, the present invention relates to a rubber composition (1) containing, per 100 parts by mass of a rubber component containing at least a diene-based rubber, 0.1 to 10 parts by mass of a compound represented by the following general formula (1):

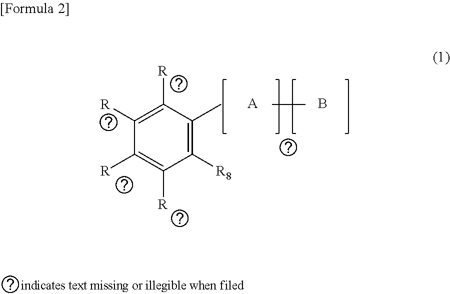

wherein at least one of R₁ to R₅ is an —OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅; and 40 to 140 parts by mass of carbon black having a nitrogen adsorption specific surface area of 140 to 250 m²/g.

The rubber composition (1) is preferably a rubber composition (2) containing 10 to 80 parts by mass of a petroleum resin per 100 parts by mass of the rubber component.

The rubber composition (1) or (2) is preferably a rubber composition (3) in which the compound represented by the general formula (1) is a naturally occurring compound.

Any one of the rubber compositions (1) to (3) is preferably a rubber composition (4) in which the compound represented by the general formula (1) is at least one of 3,4-dihydroxycinnamic acid and 3,4-dimethoxycinnamic acid.

The present invention also relates to a pneumatic tire (5) including a rubber part containing a vulcanized rubber of any one of the rubber compositions (1) to (4), and further to a pneumatic tire for motorsports (6) including a rubber part containing a vulcanized rubber of any one of the rubber compositions (1) to (4).

In addition, the above object can be achieved by the present invention as described below. That is, the present invention relates to a rubber composition (7) containing, per 100 parts by mass of a rubber component containing at least a diene-based rubber, 0.1 to 10 parts by mass of a compound having an XLogP of 0.5 or more and 10 or less; and 40 to 140 parts by mass of carbon black having a nitrogen adsorption specific surface area of 140 to 250 m²/g.

The rubber composition (7) is preferably a rubber composition (8) containing 10 to 80 parts by mass of a petroleum resin per 100 parts by mass of the rubber component.

The rubber composition (7) or (8) is preferably a rubber composition (9) in which the compound having an XLogP of 0.5 or more and 10 or less is a naturally occurring compound.

Any one of the rubber compositions (7) to (9) is preferably a rubber composition (10) in which the compound having an XLogP of 0.5 or more and 10 or less is at least one of 3,4-dihydroxycinnamic acid and 3,4-dimethoxycinnamic acid.

The present invention also relates to a pneumatic tire (11) including a rubber part containing a vulcanized rubber of any one of the rubber compositions (7) to (10), and further to a pneumatic tire (11) for motorsports including a rubber part containing a vulcanized rubber of any one of the rubber compositions (7) to (10).

The rubber composition according to the present invention contains the compound represented by the general formula (1) and carbon black having a small particle diameter and a specific nitrogen adsorption specific surface area. As a result, steering stability and WET grip performance of the finally produced vulcanized rubber are dramatically improved. The reason for achieving such an effect is considered as follows.

The compound represented by the general formula (1) has high hydrophilicity, and thus tends to aggregate in the rubber composition, so that the viscosity of the rubber composition increases. When carbon black having a small particle diameter and a nitrogen adsorption specific surface area of 140 to 250 m²/g is present in the rubber composition in such a state, due to a synergistic effect of an increase in viscosity of the rubber composition caused by the carbon black having a small particle diameter and an increase in viscosity of the rubber composition caused by the compound represented by the general formula (1), a high shear state of the rubber composition can be maintained while suppressing an excessive temperature increase during rubber kneading. As a result, while the reinforcing effect of the carbon black having a small particle diameter is sufficiently exerted, the reaction between the compound represented by the general formula (1) and the rubber component proceeds at a high level, so that the rubber hardness of the finally obtained vulcanized rubber increases, and tan δ, particularly tan δ at 0° C. (tan δ (0° C.)) increases. As a result, it is considered that the steering stability and the WET grip performance of the vulcanized rubber are improved.

The rubber composition according to the present invention contains a compound having an XLogP of 0.5 or more and 10 or less and carbon black having a small particle diameter and a specific nitrogen adsorption specific surface area. As a result, the steering stability and the WET grip performance of the finally produced vulcanized rubber are dramatically improved. The reason for achieving such an effect is considered as follows.

The compound having an XLogP of 0.5 or more and 10 or less has moderate hydrophilicity, and thus tends to aggregate in the rubber composition, so that the viscosity of the rubber composition increases. When carbon black having a small particle diameter and a nitrogen adsorption specific surface area of 140 to 250 m²/g is present in the rubber composition in such a state, due to a synergistic effect of an increase in viscosity of the rubber composition caused by the carbon black having a small particle diameter and an increase in viscosity of the rubber composition caused by the compound having an XLogP of 0.5 or more and 10 or less, a high shear state of the rubber composition can be maintained while suppressing an excessive temperature increase during rubber kneading. As a result, while the reinforcing effect of the carbon black having a small particle diameter is sufficiently exerted, the reaction between the compound having an XLogP of 0.5 or more and 10 or less and the rubber component proceeds at a high level, so that the rubber hardness of the finally obtained vulcanized rubber increases, and tan δ, particularly tan δ at 0° C. (tan δ (0° C.)) increases. As a result, it is considered that the steering stability and the WET grip performance of the vulcanized rubber are improved. In the present invention, when a compound having an XLogP of less than 0.5 is used, it is considered that the compound has too high hydrophilicity and the dispersion of a filler is deteriorated. On the other hand, when a compound having an XLogP of more than 10 is used, it is considered that the compound has low hydrophilicity, and thus has good compatibility with rubber, so that a high shear state cannot be maintained.

Since the vulcanized rubber of the rubber composition according to the present invention is excellent in steering stability and WET grip performance, it is useful as a raw material for pneumatic tires, particularly pneumatic tires for motorsports.

### DETAILED DESCRIPTION OF THE PREFERRED EMBODIMENTS

Examples of the rubber composition according to the present invention include the following first embodiment and second embodiment.

### First Embodiment

The rubber composition according to the first embodiment of the present invention contains, per 100 parts by mass of the rubber component containing at least a diene-based rubber, 0.1 to 10 parts by mass of a compound represented by the following general formula (1):

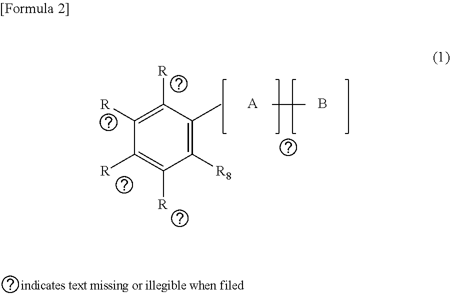

wherein at least one of R₁ to R₅ is an —OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅. The content of the compound represented by the general formula (1) is more preferably 0.5 to 5 parts by mass per 100 parts by mass of the total amount of the rubber component.

The use of a naturally occurring compound as the compound represented by the general formula (1) is more preferred in terms of environmental protection. Examples of the naturally occurring compound include 3,4-dihydroxycinnamic acid (caffeic acid), 3,4-dimethoxycinnamic acid, curcumin, sesamol, coumaric acid, ferulic acid, sinapinic acid, chlorogenic acid, rosmarinic acid, 4-(4-hydroxy-3-methoxyphenyl)-2-butanone, naringin, hesperidin, quercetin, and tocopherol. In the present invention, among these compounds, at least one of 3,4-dihydroxycinnamic acid (caffeic acid) and 3,4-dimethoxycinnamic acid is more preferably used from the viewpoint of improving the steering stability and the WET grip performance of the vulcanized rubber. The reason why the use of at least one of 3,4-dihydroxycinnamic acid and 3,4-dimethoxycinnamic acid improves the steering stability and the WET grip performance of the vulcanized rubber is not known, but there may be, for example, the following reasons (1) to (3).
(1) When 3,4-dihydroxycinnamic acid and/or 3,4-dimethoxycinnamic acid are added together with a zinc compound such as zinc oxide to the rubber composition used as a raw material, two or more molecules of 3,4-dihydroxycinnamic acid or 3,4-dimethoxycinnamic acid coordinate to zinc through hydroxy groups or methoxy groups at R₂ and R₃ positions in the rubber composition so that the molecular weight increases due to the formation of a complex;
(2) when two or more molecules of 3,4-dihydroxycinnamic acid or 3,4-dimethoxycinnamic acid form a complex, the tendency to aggregate in the rubber composition is further enhanced, so that the viscosity of the rubber composition is more effectively increased; and
(3) since carbon black having a small particle diameter and a specific nitrogen adsorption specific surface area is present in such a state, due to a synergistic effect of an increase in viscosity of the rubber composition caused by the carbon black having a small particle diameter and an increase in viscosity of the rubber composition caused by complex formation of two or more molecules of 3,4-dihydroxycinnamic acid or 3,4-dimethoxycinnamic acid, a high shear state of the rubber composition can be maintained while more effectively suppressing an excessive temperature increase during rubber kneading. As a result, while the reinforcing effect of the carbon black having a small particle diameter is further enhanced, the reaction between the compound represented by the general formula (1) and the rubber component more effectively proceeds at a high level, so that the rubber hardness of the finally obtained vulcanized rubber further increases, and tan δ, particularly tan δ at 0° C. (tan δ (0° C.)) further increases. As a result, it is considered that the steering stability and the WET grip performance of the vulcanized rubber are further improved.

It is to be noted that a non-naturally occurring compound may be also used as the compound represented by the general formula (1). Examples of the non-naturally occurring compound include 2,3-dimethoxycinnamic acid, 2,4-dimethoxycinnamic acid, 2,5-dimethoxycinnamic acid, 2,3,4-tritoxycinnamic acid, 3,4,5-tritoxycinnamic acid, protocatechuic acid, 3-(3,4-dihydroxyphenyl)-L-alanine, 5,5′,6,6′-tetrahydroxy-3,3,3′,3′-tetramethyl-1,1′-spirobiindane, carvacrol, 3,4-dimethoxyhydrocinnamic acid, 5,6-dimethoxy-1-indanone, and 3,4-dihydroxyhydrocinnamic acid.

The rubber composition according to the present invention contains 40 to 140 parts by mass of carbon black having a nitrogen adsorption specific surface area (hereinafter, also referred to as “N2SA”) of 140 to 250 m²/g per 100 parts by mass of the rubber component, in addition to the compound represented by the general formula (1). Due to a synergistic effect of both, the steering stability and the WET grip performance of the finally obtained vulcanized rubber are improved. In consideration of the steering stability and the WET grip performance of the finally obtained vulcanized rubber, the rubber composition more preferably contains 60 to 100 parts by mass of carbon black having N2SA of 140 to 250 m²/g per 100 parts by mass of the rubber component. Examples of the carbon black having N2SA of 140 to 250 m²/g include trade name “SEAST 9” (N2SA: 142 m²/g) manufactured by Tokai Carbon Co., Ltd., and trade name “DIABLACK-UX10” (N2SA: 190 m²/g) manufactured by Mitsubishi Chemical Corporation.

As the rubber component, for example, a diene-based rubber can suitably be used. Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These butadiene-based rubbers may be used singly or in combination of two or more of them. The diene-based rubber is preferably natural rubber, isoprene rubber, butadiene rubber, styrene-butadiene rubber, or a blend of two or more of them.

The rubber composition according to the present invention preferably contains 10 to 80 parts by mass of a petroleum resin per 100 parts by mass of the rubber component because the WET grip performance of the vulcanized rubber is improved. Examples of the petroleum resin include aliphatic petroleum resins, aromatic petroleum resins, and aliphatic/aromatic copolymer-based petroleum resins. The aliphatic petroleum resin is a resin obtained by cationically polymerizing unsaturated monomers such as isoprene or cyclopentadiene which is a petroleum fraction corresponding to 4 to 5 carbon atoms (C5 fraction) (also referred to as C5 petroleum resin.), and may be hydrogenated. The aromatic petroleum resin is a resin obtained by cationically polymerizing monomers such as vinyl toluene, alkyl styrene, or indene which is a petroleum fraction (C9 fraction) corresponding to 8 to 10 carbon atoms (also referred to as C9 petroleum resin.), and may be hydrogenated. The aliphatic/aromatic copolymer-based petroleum resin is a resin obtained by copolymerizing the C5 fraction and the C9 fraction (also referred to as a C5/C9 petroleum resin.), and may be hydrogenated. In consideration of the WET grip performance of the finally obtained vulcanized rubber, the rubber composition more preferably contains 40 to 60 parts by mass of the petroleum resin per 100 parts by mass of the rubber component.

The rubber composition according to the present invention also preferably contains silica as a filler. Examples of the silica to be used include silicas usually used for rubber reinforcement, such as wet silica, dry silica, sol-gel silica, and surface-treated silica. Among these, wet silica is preferred.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e. g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

The rubber composition according to the present invention may contain, as a filler, carbon black other than carbon black having N2SA of 140 to 250 m²/g. Examples of the carbon black other than carbon black having N2SA of 140 to 250 m²/g that can be used include: carbon blacks usually used in the rubber industry, such as SAF, ISAF, HAF, FEF, and GPF; and conductive carbon blacks such as acetylene black and ketjen black.

The rubber composition according to the present invention may contain, in addition to the rubber component, the compound represented by the general formula (1), the carbon black having N2SA of 140 to 250 m²/g, the filler, and the petroleum resin, a vulcanizing agent, a vulcanization accelerator, an antiaging agent, stearic acid, a softener such as wax or oil, a processing aid, etc.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the sulfur is preferably 0.5 to 5 parts by mass per 100 parts by mass of the rubber component in the rubber composition according to the present invention.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination.

In the rubber composition according to the present invention, examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination.

The rubber composition according to the present invention is obtained by kneading the rubber component, the compound represented by the general formula (1), the carbon black having N2SA of 140 to 250 m²/g, the filler, and the petroleum resin, and further the vulcanizing agent, the vulcanization accelerator, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

### Second Embodiment

The rubber composition according to the second embodiment of the present invention contains 0.1 to 10 parts by mass of a compound having an XLogP of 0.5 or more and 10 or less per 100 parts by mass of the rubber component containing at least a diene-based rubber. The content of the compound having an XLogP of 0.5 or more and 10 or less is more preferably 0.5 to 5 parts by mass per 100 parts by mass of the total amount of the rubber component.

Hereinafter, XLogP in the present invention will be described.

The lipid solubility of a compound is a factor that greatly affects not only solubility but also pharmacokinetics such as absorption and metabolism, and a representative descriptor representing the lipid solubility of a compound is LogP, which is an octanol/water partition coefficient. P of LogP is a concentration ratio in an equilibrium state between the organic layer (octanol layer) and the aqueous layer of the molecule, and a common logarithm thereof is LogP. A large number indicates that the concentration in the organic layer is high, which means that the lipid solubility is high. However, LogP has a practical problem, and for example, a value of LogP can be experimentally obtained for each compound, but is not so realistic in terms of time and cost, and the number of reported compounds is not so large. In addition, there is a disadvantage that the LogP value of a compound that has not yet been synthesized cannot be experimentally obtained.

In order to solve the above-mentioned problem of LogP, there is an approach of estimating LogP by decomposing a molecule into individual atoms and calculating a sum of respective contributions, and among the atom-based approaches, only the XLogP algorithm adds a correction term, and a latest model of the XLogP series is described in a paper “Computation of Octanol-Water Partition Coefficients by Guiding an Additive Model with Knowledge”. The value of LogP listed in PubChem, a chemical molecules database, maintained and managed by the National Center for Biotechnology Information (NCBI), a division of the National Library of Medicine (NLM) under the National Institutes of Health (NIH), is the basis of XLogP.

In the present invention, the use of a naturally occurring compound as the compound having an XLogP of 0.5 or more and 10 or less is more preferred in terms of environmental protection. Examples of the naturally occurring compound include 3,4-dihydroxycinnamic acid (caffeic acid) (XLogP=1.2), 3,4-dimethoxycinnamic acid (XLogP=1.8), curcumin (XLogP=3.2), sesamol (XLogP=1.2), coumaric acid (XLogP=1.5), cinnamic acid (XLogP=2.1), rosmarinic acid (XLogP=2.4), ferulic acid (XLogP=1.5), sinapinic acid (XLogP=1.5), and 4-(4-hydroxy-3-methoxyphenyl)-2-butanone (XLogP=0.8). In the present invention, among these compounds, at least one of 3,4-dihydroxycinnamic acid (caffeic acid) and 3,4-dimethoxycinnamic acid is more preferably used from the viewpoint of improving the steering stability and the WET grip performance of the vulcanized rubber. The reason why the use of at least one of 3,4-dihydroxycinnamic acid and 3,4-dimethoxycinnamic acid improves the steering stability and the WET grip performance of the vulcanized rubber is not known, but there may be, for example, the following reasons (1) to (3).
(1) When 3,4-dihydroxycinnamic acid and/or 3,4-dimethoxycinnamic acid are added together with a zinc compound such as zinc oxide to the rubber composition used as a raw material, two or more molecules of 3,4-dihydroxycinnamic acid or 3,4-dimethoxycinnamic acid coordinate to zinc through hydroxy groups or methoxy groups at R₂ and R₃ positions in the rubber composition so that the molecular weight increases due to the formation of a complex;
(2) when two or more molecules of 3,4-dihydroxycinnamic acid or 3,4-dimethoxycinnamic acid form a complex, the tendency to aggregate in the rubber composition is further enhanced, so that the viscosity of the rubber composition is more effectively increased; and
(3) since carbon black having a small particle diameter and a specific nitrogen adsorption specific surface area is present in such a state, due to a synergistic effect of an increase in viscosity of the rubber composition caused by the carbon black having a small particle diameter and an increase in viscosity of the rubber composition caused by complex formation of two or more molecules of 3,4-dihydroxycinnamic acid or 3,4-dimethoxycinnamic acid, a high shear state of the rubber composition can be maintained while more effectively suppressing an excessive temperature increase during rubber kneading. As a result, while the reinforcing effect of the carbon black having a small particle diameter is further enhanced, the reaction between the compound having an XLogP of 0.5 or more and 10 or less and the rubber component more effectively proceeds at a high level, so that the rubber hardness of the finally obtained vulcanized rubber further increases, and tan δ, particularly tan δ at 0° C. (tan δ (0° C.)) further increases. As a result, it is considered that the steering stability and the WET grip performance of the vulcanized rubber are further improved.

It is to be noted that a non-naturally occurring compound may be also used as the compound having an XLogP of 0.5 or more and 10 or less. Examples of the non-naturally occurring compound include 2,3-dimethoxycinnamic acid (XLogP=1.8), 2,4-dimethoxycinnamic acid (XLogP=1.8), 2,5-dimethoxycinnamic acid (XLogP=1.8), 2,3,4-tritoxycinnamic acid (XLogP=1.7), 3,4,5-tritoxycinnamic acid (XLogP=1.4), protocatechuic acid (XLogP=1.1), catechol (XLogP=0.9), 5,5′,6,6′-tetrahydroxy-3,3,3′,3′-tetramethyl-1,1′-spirobiindane (XLogP=5.1), carvacrol (XLogP=3.1), 3,4-dimethoxyhydrocinnamic acid (XLogP=1.2), and 5,6-dimethoxy-1-indanone (XLogP=1.6).

The rubber composition according to the present invention contains 40 to 140 parts by mass of carbon black having a nitrogen adsorption specific surface area (hereinafter, also referred to as “N2SA”) of 140 to 250 m²/g per 100 parts by mass of the rubber component, in addition to the compound having an XLogP of 0.5 or more and 10 or less. Due to a synergistic effect of both, the steering stability and the WET grip performance of the finally obtained vulcanized rubber are improved. In consideration of the steering stability and the WET grip performance of the finally obtained vulcanized rubber, the rubber composition more preferably contains 60 to 100 parts by mass of carbon black having N2SA of 140 to 250 m²/g per 100 parts by mass of the rubber component. Examples of the carbon black having N2SA of 140 to 250 m²/l g include trade name “SEAST 9” (N2SA: 142 m²/g) manufactured by Tokai Carbon Co., Ltd., and trade name “DIABLACK-UX10” (N2SA: 190 m²/g) manufactured by Mitsubishi Chemical Corporation.

As the rubber component, for example, a diene-based rubber can suitably be used. Examples of the diene-based rubber include, but are not limited to, natural rubber (NR), isoprene rubber (IR), butadiene rubber (BR), styrene-butadiene rubber (SBR), acrylonitrile-butadiene rubber (NBR), chloroprene rubber (CR), styrene-isoprene copolymer rubber, a butadiene-isoprene copolymer, and styrene-isoprene-butadiene copolymer rubber. These butadiene-based rubbers may be used singly or in combination of two or more of them. The diene-based rubber is preferably natural rubber, isoprene rubber, butadiene rubber, styrene-butadiene rubber, or a blend of two or more of them.

The rubber composition according to the present invention preferably contains 10 to 80 parts by mass of a petroleum resin per 100 parts by mass of the rubber component because the WET grip performance of the vulcanized rubber is improved. Examples of the petroleum resin include aliphatic petroleum resins, aromatic petroleum resins, and aliphatic/aromatic copolymer-based petroleum resins. The aliphatic petroleum resin is a resin obtained by cationically polymerizing unsaturated monomers such as isoprene or cyclopentadiene which is a petroleum fraction corresponding to 4 to 5 carbon atoms (C5 fraction) (also referred to as C5 petroleum resin.), and may be hydrogenated. The aromatic petroleum resin is a resin obtained by cationically polymerizing monomers such as vinyl toluene, alkyl styrene, or indene which is a petroleum fraction (C9 fraction) corresponding to 8 to 10 carbon atoms (also referred to as C9 petroleum resin.), and may be hydrogenated. The aliphatic/aromatic copolymer-based petroleum resin is a resin obtained by copolymerizing the C5 fraction and the C9 fraction (also referred to as a C5/C9 petroleum resin.), and may be hydrogenated. In consideration of the WET grip performance of the finally obtained vulcanized rubber, the rubber composition more preferably contains 40 to 60 parts by mass of the petroleum resin per 100 parts by mass of the rubber component.

The rubber composition according to the present invention also preferably contains silica as a filler. Examples of the silica to be used include silicas usually used for rubber reinforcement, such as wet silica, dry silica, sol-gel silica, and surface-treated silica. Among these, wet silica is preferred.

When silica is contained as a filler, a silane coupling agent is also preferably contained together. The silane coupling agent is not limited as long as sulfur is contained in the molecule thereof, and various silane coupling agents to be added to rubber compositions together with silica may be used. Examples of such silane coupling agents include: sulfidesilanes such as bis(3-triethoxysilylpropyl)tetrasulfide (e.g., “Si69” manufactured by Degussa), bis(3-triethoxysilylpropyl)disulfide (e.g., “Si75” manufactured by Degussa), bis(2-triethoxysilylethyl)tetrasulfide, bis(4-triethoxysilylbutyl)disulfide, bis(3-trimethoxysilylpropyl)tetrasulfide, and bis(2-trimethoxysilylethyl)disulfide; mercaptosilanes such as γ-mercaptopropyltrimethoxysilane, γ-mercaptopropyltriethoxysilane, mercaptopropylmethyldimethoxysilane, mercaptopropyldimethylmethoxysilane, and mercaptoethyltriethoxysilane; and protected mercaptosilanes such as 3-octanoylthio-1-propyltriethoxysilane and 3-propionylthiopropyltrimethoxysilane.

The rubber composition according to the present invention may contain, as a filler, carbon black other than carbon black having N2SA of 140 to 250 m²/g. Examples of the carbon black other than carbon black having N2SA of 140 to 250 m²/g that can be used include: carbon blacks usually used in the rubber industry, such as SAF, ISAF, HAF, FEF, and GPF; and conductive carbon blacks such as acetylene black and ketjen black.

The rubber composition according to the present invention may contain, in addition to the rubber component, the compound having an XLogP of 0.5 or more and 10 or less, the carbon black having N2SA of 140 to 250 m²/g, the filler, and the petroleum resin, a vulcanizing agent, a vulcanization accelerator, an antiaging agent, stearic acid, a softener such as wax or oil, a processing aid, etc.

As the vulcanizing agent, sulfur can suitably be used. The sulfur may be ordinary sulfur for rubber, and sulfur such as powdered sulfur, precipitated sulfur, insoluble sulfur, or highly dispersible sulfur can be used. The content of the sulfur is preferably 0.5 to 5 parts by mass per 100 parts by mass of the rubber component in the rubber composition according to the present invention.

Examples of the vulcanization accelerator include vulcanization accelerators usually used for rubber vulcanization, such as a sulfenamide-based vulcanization accelerator, a thiuram-based vulcanization accelerator, a thiazole-based vulcanization accelerator, a thiourea-based vulcanization accelerator, a guanidine-based vulcanization accelerator, and a dithiocarbamic acid salt-based vulcanization accelerator, and these may be used singly or in an appropriate combination.

In the rubber composition according to the present invention, examples of the antiaging agent include antiaging agents usually used for rubber, such as an aromatic amine-based antiaging agent, an amine-ketone-based antiaging agent, a monophenol-based antiaging agent, a bisphenol-based antiaging agent, a polyphenol-based antiaging agent, a dithiocarbamic acid salt-based antiaging agent, and a thiourea-based antiaging agent, and these may be used singly or in an appropriate combination.

The rubber composition according to the present invention is obtained by kneading the rubber component, the compound having an XLogP of 0.5 or more and 10 or less, the carbon black having N2SA of 140 to 250 m²/g, the filler, and the petroleum resin, and further the vulcanizing agent, the vulcanization accelerator, the antiaging agent, stearic acid, the softener such as wax or oil, the processing aid, etc. with the use of a kneading machine usually used in the rubber industry, such as a Banbury mixer, a kneader, or a roll.

A method for blending the above components is not limited, and any one of the following methods may be used: a method in which components to be blended other than vulcanization-type compounding agents such as a vulcanizing agent and a vulcanization accelerator are previously kneaded to prepare a master batch, the remaining components are added to the master batch, and the resultant is further kneaded, a method in which components are added in any order and kneaded, and a method in which all the components are added at the same time and kneaded.

The vulcanized rubber of the rubber composition according to the present invention is excellent in steering stability and WET grip performance. Therefore, the rubber composition according to the present invention is useful as a raw material for pneumatic tires, but is particularly useful as a raw material for pneumatic tires for motorsports that are required to have high steering stability and WET grip performance. Furthermore, when the rubber composition is used as a raw material for a rubber part constituting a tread part of a pneumatic tire for motorsports, the steering stability and the WET grip performance of the finally produced pneumatic tire for motorsports are extremely effectively exhibited, which is most preferable.

### EXAMPLES

Hereinbelow, the configuration and effect of the present invention will be described with reference to specific examples etc.

### Preparation of Rubber Compositions

Rubber compositions of Examples 1 to 9 and Comparative Examples 1 to 3 were prepared according to formulations shown in Tables 1 to 2 and kneaded using a usual Banbury mixer. Compounding agents listed in Tables 1 to 2 are shown below (in Tables 1 to 2, the content of each of the compounding agents added is expressed in parts by mass per 100 parts by mass of the rubber component).
Styrene-butadiene rubber; manufactured by JSR Corporation, trade name “JSR0202”
Carbon black 1; manufactured by Mitsubishi Chemical Corporation, trade name “DIABLACK-UX10” (N2SA: 190 m²/g).
Carbon black 2; manufactured by Tokai Carbon Co., Ltd., trade name “SEAST 9” (N2SA: 142 m²/g)
Carbon black 3; manufactured by Mitsubishi Chemical Corporation, trade name “DIABLACK N339” (N2SA: 91 m²/g).
Silica; manufactured by TOSOH SILICA CORPORATION, trade name “Nipsil AQ”
Silane coupling agent; Bis(3-triethoxysilylpropyl)tetrasulfide, “Si69” manufactured by Evonik Industries AG
Petroleum resin (aliphatic petroleum resin); manufactured by Zeon Corporation, trade name “Quinton M100” (softening point: 95° C.)
Oil; manufactured by JX Nippon Oil & Energy Corporation, trade name “Process NC140”
Zinc white; manufactured by MITSUI MINING & SMELTING CO., LTD., trade name “Zinc white #3”
Stearic acid; manufactured by Kao Corporation, trade name “LUNAC S-20”
Antiaging agent; manufactured by Sumitomo Chemical Co., Ltd., trade name: “Antigen 6C”
3,4-Dimethoxycinnamic acid
3,4-Dihydroxycinnamic acid (caffeic acid)
Acetamide cinnamic acid (compound not corresponding to compound represented by general formula (1))
Sulfur; manufactured by Tsurumi Chemical Industry Co., ltd., trade name “Powder Sulfur”
Vulcanization accelerator; manufactured by Ouchi Shinko Chemical Industrial Co., Ltd., trade name “NOCCELER CZ”

The rubber hardness (Hs.) and tan δ (0° C.) of the vulcanized rubber of each of the rubber compositions of Examples 1 to 9 and Comparative Examples 1 to 3 were evaluated by the following methods.

### Rubber Hardness of Vulcanized Rubber (Hs.)

In the evaluation of the rubber hardness, in test pieces of sample rubbers obtained by heating and vulcanizing the rubber compositions of Examples 1 to 9 and Comparative Examples 1 to 3 at 160° C. for 30 minutes using a predetermined mold, the hardness at a temperature of 23° C. was measured by a durometer type A in accordance with JIS K6253, and expressed as an index when the value in Comparative Example 1 is 100. The larger the index is, the higher the rubber hardness is at room temperature, which indicates excellent steering stability when used in the tread part of the pneumatic tire.

### tan δ (0° C.) of Vulcanized Rubber

The rubber compositions of Examples 1 to 9 and Comparative Examples 1 to 3 were heated and vulcanized at 160° C. for 30 minutes using a predetermined mold, and the thus obtained sample rubbers were used as measurement samples. The storage elastic modulus (E′) and loss elastic modulus (E″) were measured for each measurement sample by a dynamic viscoelasticity measuring device (product name “Fully Automatic Viscoelasticity Analyzer VR-7110”, manufactured by Ueshima Seisakusho Co., Ltd.) to measure tan δ (0° C.). In Tables 1 to 2, the measured value was expressed as an index when the value of tan δ (0° C.) in Comparative Example 1 is 100. The larger the index is, the better the WET grip performance is when used in the tread part of the pneumatic tire. Measurement conditions are as follows.
Size of measurement sample: length 40 mm, width 3 mm, thickness 2 mm
Measurement mode: Tensile mode
Measurement temperature: 0° C.
Frequency: 100 Hz
Dynamic strain: 0.15%

TABLE 1

| Comparative | Comparative | Comparative | Example | Example | Example | Example |
|---|---|---|---|---|---|---|
| Example 1 | Example 2 | Example 3 | 1 | 2 | 3 | 4 |

(Formulation)

| | | | | | | | |
|---|---|---|---|---|---|---|---|
| Styrene-butadiene rubber | 100 | 100 | 100 | 100 | 100 | 100 | 100 |
| Carbon black 1 | 80 | 80 | | 80 | 80 | 80 | 80 |
| Carbon black 2 | | | | | | | |
| Carbon black 3 | | | 80 | | | | |
| Silica | 20 | 20 | 20 | 20 | 20 | 20 | 20 |
| Silane coupling agent | 1.6 | 1.6 | 1.6 | 1.6 | 1.6 | 1.6 | 1.6 |
| Petroleum resin | 45 | 45 | 45 | 45 | 45 | 45 | 45 |
| Oil | 45 | 45 | 45 | 45 | 45 | 45 | 45 |
| Zinc white | 3 | 3 | 3 | 3 | 3 | 3 | 3 |
| Stearic acid | 2 | 2 | 2 | 2 | 2 | 2 | 2 |
| Antiaging agent | 2 | 2 | 2 | 2 | 2 | 2 | 2 |
| 3,4-Dimethoxycinnamic acid | | | 2 | 0.5 | 2 | 5 | |
| (corresponding to compound | | | | | | | |
| represented by general | | | | | | | |
| formula (1)) | | | | | | | |
| 3,4-Dihydroxycinnamic acid | | | | | | | 2 |
| (corresponding to compound | | | | | | | |
| represented by general | | | | | | | |
| formula (1)) | | | | | | | |
| Acetamide cinnamic acid | | 2 | | | | | |
| (not corresponding to | | | | | | | |
| compound represented by | | | | | | | |
| general formula (1)) | | | | | | | |
| Sulfur | 2 | 2 | 2 | 2 | 2 | 2 | 2 |
| Vulcanization accelerator | 2 | 2 | 2 | 2 | 2 | 2 | 2 |

(Physical properties (index))

| | | | | | | | |
|---|---|---|---|---|---|---|---|
| Hs. | 100 | 105 | 99 | 101 | 105 | 108 | 106 |
| tanδ (0° C.) | 100 | 95 | 99 | 102 | 106 | 109 | 106 |

As can be seen from the results shown in Table 1, the vulcanized rubber of the rubber composition of Comparative Example 2 contains acetamide cinnamic acid that is a compound not corresponding to the compound represented by the general formula (1), and thus, when used in the tread part of the pneumatic tire, the WET grip performance is not improved. Also, it can be seen that the vulcanized rubber of the rubber composition of Comparative Example 3 contains Carbon black 3 having a low N2SA of 91 m²/g, and thus, when used in the tread part of the pneumatic tire, the steering stability and the WET grip performance are not improved. On the other hand, it can be seen that when the vulcanized rubbers of the rubber compositions of Examples 1 to 3 are used in the tread part of the pneumatic tire, both the steering stability and the WET grip performance are improved in a well-balanced manner due to a synergistic effect of 3,4-dimethoxycinnamic acid corresponding to the compound represented by the general formula (1) and Carbon black 1 having a predetermined N2SA. In addition, as can be seen from the results shown in Example 4, the same effect can also be obtained by the vulcanized rubber of the rubber composition containing 3,4-dihydroxycinnamic acid corresponding to the compound represented by the general formula (1).

TABLE 2

| Comparative | Example | Example | Example | Example | Example |
|---|---|---|---|---|---|
| Example 1 | 5 | 6 | 7 | 8 | 9 |

(Formulation)

| | | | | | | |
|---|---|---|---|---|---|---|
| Styrene-butadiene rubber | 100 | 100 | 100 | 100 | 100 | 100 |
| Carbon black 1 | 80 | 60 | 100 | 90 | 70 | |
| Carbon black 2 | | | | | | 120 |
| Carbon black 3 | | | | | | |
| Silica | 20 | 40 | | 20 | 20 | 10 |
| Silane coupling agent | 1.6 | 3.2 | | 1.6 | 1.6 | 0.8 |
| Petroleum resin | 45 | 45 | 40 | 30 | 60 | 20 |
| Oil | 45 | 45 | 50 | 50 | 20 | 45 |
| Zinc white | 3 | 3 | 3 | 3 | 3 | 3 |
| Stearic acid | 2 | 2 | 2 | 2 | 2 | 2 |
| Antiaging agent | 2 | 2 | 2 | 2 | 2 | 2 |
| 3,4-Dimethoxycinnamic acid | | 2 | 2 | 2 | 2 | 2 |
| (corresponding to compound | | | | | | |
| represented by general | | | | | | |
| formula (1)) | | | | | | |
| 3,4-Dihydroxycinnamic acid | | | | | | |
| (corresponding to compound | | | | | | |
| represented by general | | | | | | |
| formula (1)) | | | | | | |
| Acetamide cinnamic acid | | | | | | |
| (not corresponding to | | | | | | |
| compound represented by | | | | | | |
| general formula (1)) | | | | | | |
| Sulfur | 2 | 2 | 2 | 2 | 2 | 2 |
| Vulcanization accelerator | 2 | 2 | 2 | 2 | 2 | 2 |

(Physical properties (index))

| | | | | | | |
|---|---|---|---|---|---|---|
| Hs. | 100 | 107 | 108 | 102 | 103 | 103 |
| tanδ (0° C.) | 100 | 105 | 111 | 108 | 109 | 111 |

As can be seen from the results shown in Table 2, when the vulcanized rubbers of the rubber compositions of Examples 5 to 8 are used in the tread part of the pneumatic tire, both the steering stability and the WET grip performance are improved in a well-balanced manner due to a synergistic effect of 3,4-dimethoxycinnamic acid corresponding to the compound represented by the general formula (1) and Carbon black 1 having a predetermined N2SA even when the content of Carbon black 1 is varied within a predetermined range. In addition, as can be seen from the results shown in Example 9, the same effect can also be obtained by the vulcanized rubber of the rubber composition containing Carbon black 2 having a predetermined N2SA.

### Preparation of Rubber Compositions

Rubber compositions of Examples 10 to 21 and Comparative Examples 4 to 7 were prepared according to formulations shown in Tables 3 to 4 and kneaded using a usual Banbury mixer. Compounding agents listed in Tables 3 to 4 are shown below (in Tables 3 to 4, the content of each of the compounding agents added is expressed in parts by mass per 100 parts by mass of the rubber component).
Styrene-butadiene rubber; manufactured by JSR Corporation, trade name “JSR0202”
Carbon black 1; manufactured by Mitsubishi Chemical Corporation, trade name “DIABLACK-UX10” (N2SA: 190 m²/g)
Carbon black 2; manufactured by Tokai Carbon Co., Ltd., trade name “SEAST 9” (N2SA: 142 m²/g)
Carbon black 3; manufactured by Mitsubishi Chemical Corporation, trade name “DIABLACK N339” (N2SA: 91 m²/g)
Silica; manufactured by TOSOH SILICA CORPORATION, trade name “Nipsil AQ”
Silane coupling agent; Bis(3-triethoxysilylpropyl)tetrasulfide, “Si69” manufactured by Evonik Industries AG
Petroleum resin (aliphatic petroleum resin); manufactured by Zeon Corporation, trade name “Quinton M100” (softening point: 95° C.)
Oil; manufactured by JX Nippon Oil & Energy Corporation, trade name “Process NC140”
Zinc white; manufactured by MITSUI MINING & SMELTING CO., LTD., trade name “Zinc white #3”
Stearic acid; manufactured by Kao Corporation, trade name “LUNAC S-20”
Antiaging agent; manufactured by Sumitomo Chemical Co., Ltd., trade name: “Antigen 6C”
3,4-Dimethoxycinnamic acid (XLogP=1.8)
3,4-Dihydroxycinnamic acid (XLogP=1.2)
Catechol (XLogP=0.9)
Cinnamic acid (XLogP=2.1)
5,5′,6,6′-Tetrahydroxy-3,3,3′,3′-tetramethyl-1,1′-spirobiindane (XLogP=5.1)
Acetamide cinnamic acid (XLogP=0)
Tocopherol (XLogP=10.7)
Sulfur; manufactured by Tsurumi Chemical Industry Co., ltd., trade name “Powder Sulfur”
Vulcanization accelerator; manufactured by Ouchi Shinko Chemical Industrial Co., Ltd., trade name “NOCCELER CZ”

The rubber hardness (Hs.) and tan δ (0° C.) of the vulcanized rubber of each of the rubber compositions of Examples 10 to 21 and Comparative Examples 4 to 7 were evaluated by the following methods.

### Rubber Hardness of Vulcanized Rubber (Hs.)

In the evaluation of the rubber hardness, in test pieces of sample rubbers obtained by heating and vulcanizing the rubber compositions of Examples 10 to 21 and Comparative Examples 4 to 7 at 160° C. for 30 minutes using a predetermined mold, the hardness at a temperature of 23° C. was measured by a durometer type A in accordance with JIS K6253, and expressed as an index when the value in Comparative Example 4 is 100. The larger the index is, the higher the rubber hardness is at room temperature, which indicates excellent steering stability when used in the tread part of the pneumatic tire.

### tan δ (0° C.) of Vulcanized Rubber

The rubber compositions of Examples 10 to 21 and Comparative Examples 4 to 7 were heated and vulcanized at 160° C. for 30 minutes using a predetermined mold, and the thus obtained sample rubbers were used as measurement samples. The storage elastic modulus (E′) and loss elastic modulus (E″) were measured for each measurement sample by a dynamic viscoelasticity measuring device (product name “Fully Automatic Viscoelasticity Analyzer VR-7110”, manufactured by Ueshima Seisakusho Co., Ltd.) to measure tan δ (0° C.). In Tables 3 to 4, the measured value was expressed as an index when the value of tan δ (0° C.) in Comparative Example 4 is 100. The larger the index is, the better the WET grip performance is when used in the tread part of the pneumatic tire. Measurement conditions are as follows.
Size of measurement sample: length 40 mm, width 3 mm, thickness 2 mm
Measurement mode: Tensile mode
Measurement temperature: 0° C.
Frequency: 100 Hz
Dynamic strain: 0.15%

TABLE 3

| Comparative | Comparative | Comparative | Comparative | Example | Example |
|---|---|---|---|---|---|
| Example 4 | Example 5 | Example 6 | Example 7 | 10 | 11 |

(Formulation)

| | | | | | | |
|---|---|---|---|---|---|---|
| Styrene-butadiene rubber | 100 | 100 | 100 | 100 | 100 | 100 |
| Carbon black 1 | 80 | 80 | 80 | | 80 | 80 |
| Carbon black 2 | | | | | | |
| Carbon black 3 | | | | 80 | | |
| Silica | 20 | 20 | 20 | 20 | 20 | 20 |
| Silane coupling agent | 1.6 | 1.6 | 1.6 | 1.6 | 1.6 | 1.6 |
| Petroleum resin | 45 | 45 | 45 | 45 | 45 | 45 |
| Oil | 45 | 45 | 45 | 45 | 45 | 45 |
| Zinc white | 3 | 3 | 3 | 3 | 3 | 3 |
| Stearic acid | 2 | 2 | 2 | 2 | 2 | 2 |
| Antiaging agent | 2 | 2 | 2 | 2 | 2 | 2 |
| 3,4-Dimethoxycinnamic acid | | | | 2 | 0.5 | 2 |
| (XlogP = 1.8) | | | | | | |
| 3,4-Dihydroxycinnamic acid | | | | | | |
| (XlogP = 1.2) | | | | | | |
| Catechol | | | | | | |
| (XlogP = 0.9) | | | | | | |
| Cinnamic acid | | | | | | |
| (XlogP = 2.1) | | | | | | |
| 5,5′,6,6′-Tetrahydroxy- | | | | | | |
| 3,3,3′,3′-tetramethyl-1,1′- | | | | | | |
| spirobiindane | | | | | | |
| (XlogP = 5.1) | | | | | | |
| Acetamide cinnamic acid | | 2 | | | | |
| (XlogP = 0) | | | | | | |
| Tocopherol | | | 3.2 | | | |
| (XlogP = 10.7) | | | | | | |
| Sulfur | 2 | 2 | 2 | 2 | 2 | 2 |
| Vulcanization accelerator | 2 | 2 | 2 | 2 | 2 | 2 |

(Physical properties (index))

| | | | | | | |
|---|---|---|---|---|---|---|
| Hs. | 100 | 105 | 96 | 99 | 101 | 105 |
| tanδ (0° C.) | 100 | 95 | 97 | 99 | 102 | 106 |

| | Example | Example | Example | Example | Example |
|---|---|---|---|---|---|
| | 12 | 13 | 14 | 15 | 16 |
| (Formulation) | | | | | |
| Styrene-butadiene rubber | 100 | 100 | 100 | 100 | 100 |
| Carbon black 1 | 80 | 80 | 80 | 80 | 80 |
| Carbon black 2 | | | | | |
| Carbon black 3 | | | | | |
| Silica | 20 | 20 | 20 | 20 | 20 |
| Silane coupling agent | 1.6 | 1.6 | 1.6 | 1.6 | 1.6 |
| Petroleum resin | 45 | 45 | 45 | 45 | 45 |
| Oil | 45 | 45 | 45 | 45 | 45 |
| Zinc white | 3 | 3 | 3 | 3 | 3 |
| Stearic acid | 2 | 2 | 2 | 2 | 2 |
| Antiaging agent | 2 | 2 | 2 | 2 | 2 |
| 3,4-Dimethoxycinnamic acid | 5 | | | | |
| (XlogP = 1.8) | | | | | |
| 3,4-Dihydroxycinnamic acid | | 2 | | | |
| (XlogP = 1.2) | | | | | |
| Catechol | | | 0.8 | | |
| (XlogP = 0.9) | | | | | |
| Cinnamic acid | | | | 1.1 | |
| (XlogP = 2.1) | | | | | |
| 5,5′,6,6′-Tetrahydroxy- | | | | | 2.3 |
| 3,3,3′,3′-tetramethyl-1,1′- | | | | | |
| spirobiindane | | | | | |
| (XlogP = 5.1) | | | | | |
| Acetamide cinnamic acid | | | | | |
| (XlogP = 0) | | | | | |
| Tocopherol | | | | | |
| (XlogP = 10.7) | | | | | |
| Sulfur | 2 | 2 | 2 | 2 | 2 |
| Vulcanization accelerator | 2 | 2 | 2 | 2 | 2 |
| (Physical properties (index)) | | | | | |
| Hs. | 108 | 106 | 106 | 107 | 100 |
| tanδ (0° C.) | 109 | 106 | 102 | 102 | 102 |

As can be seen from the results shown in Table 3, the vulcanized rubber of the rubber composition of Comparative Example 5 contains acetamide cinnamic acid having an XLogP of 0, and thus, when used in the tread part of the pneumatic tire, the WET grip performance is not improved. It can be seen that the vulcanized rubber of the rubber composition of Comparative Example 6 contains tocopherol having an XLogP of 10.7, and thus, when used in the tread part of the pneumatic tire, the steering stability and the WET grip performance are not improved. Also, it can be seen that the vulcanized rubber of the rubber composition of Comparative Example 7 contains Carbon black 3 having a low N2SA of 91 m²/g, and thus, when used in the tread part of the pneumatic tire, the steering stability and the WET grip performance are not improved. On the other hand, it can be seen that when the vulcanized rubbers of the rubber compositions of Examples 10 to 12 are used in the tread part of the pneumatic tire, both the steering stability and the WET grip performance are improved in a well-balanced manner due to a synergistic effect of 3,4-dimethoxycinnamic acid having an XLogP of 0.5 or more and 10 or less (XLogP=1.8) and Carbon black 1 having a predetermined N2SA. In addition, as can be seen from the results shown in Examples 13 to 15, the same effect can also be obtained by the vulcanized rubber of the rubber composition containing 3,4-dihydroxycinnamic acid (XLogP=1.2), catechol (XLogP=0.9), cinnamic acid (XLogP=2.1), and 5,5′,6,6′-tetrahydroxy-3,3,3′,3′-tetramethyl-1,1′-spirobiindane (XLogP=5.1).

TABLE 4

| Comparative | Example | Example | Example | Example | Example |
|---|---|---|---|---|---|
| Example 4 | 17 | 18 | 19 | 20 | 21 |

(Formulation)

| | | | | | | |
|---|---|---|---|---|---|---|
| Styrene-butadiene rubber | 100 | 100 | 100 | 100 | 100 | 100 |
| Carbon black 1 | 80 | 60 | 100 | 90 | 70 | |
| Carbon black 2 | | | | | | 120 |
| Carbon black 3 | | | | | | |
| Silica | 20 | 40 | | 20 | 20 | 10 |
| Silane coupling agent | 1.6 | 3.2 | | 1.6 | 1.6 | 0.8 |
| Petroleum resin | 45 | 45 | 40 | 30 | 60 | 20 |
| Oil | 45 | 45 | 50 | 50 | 20 | 45 |
| Zinc white | 3 | 3 | 3 | 3 | 3 | 3 |
| Stearic acid | 2 | 2 | 2 | 2 | 2 | 2 |
| Antiaging agent | 2 | 2 | 2 | 2 | 2 | 2 |
| 3,4-Dimethoxycinnamic acid | | 2 | 2 | 2 | 2 | 2 |
| (XlogP = 1.8) | | | | | | |
| 3,4-Dihydroxycinnamic acid | | | | | | |
| (XlogP = 1.2) | | | | | | |
| Catechol | | | | | | |
| (XlogP = 0.9) | | | | | | |
| Cinnamic acid | | | | | | |
| (XlogP = 2.1) | | | | | | |
| 5,5′,6,6′-Tetrahydroxy- | | | | | | |
| 3,3,3′,3′-tetramethyl-1,1′- | | | | | | |
| spirobiindane | | | | | | |
| (XlogP = 5.1) | | | | | | |
| Acetamide cinnamic acid | | | | | | |
| (XlogP = 0) | | | | | | |
| Tocopherol | | | | | | |
| (XlogP = 10.7) | | | | | | |
| Sulfur | 2 | 2 | 2 | 2 | 2 | 2 |
| Vulcanization accelerator | 2 | 2 | 2 | 2 | 2 | 2 |

(Physical properties (index))

| | | | | | | |
|---|---|---|---|---|---|---|
| Hs. | 100 | 107 | 108 | 102 | 103 | 103 |
| tanδ (0° C.) | 100 | 105 | 111 | 108 | 109 | 111 |

As can be seen from the results shown in Table 4, when the vulcanized rubbers of the rubber compositions of Examples 17 to 20 are used in the tread part of the pneumatic tire, both the steering stability and the WET grip performance are improved in a well-balanced manner due to a synergistic effect of 3,4-dimethoxycinnamic acid having an XLogP of 0.5 or more and 10 or less (XLogP=1.8) and Carbon black 1 having a predetermined N2SA even when the content of Carbon black 1 is varied within a predetermined range. In addition, as can be seen from the results shown in Example 21, the same effect can also be obtained by the vulcanized rubber of the rubber composition containing Carbon black 2 having a predetermined N2SA.

What is claimed is:

1. A rubber composition comprising, per 100 parts by mass of a rubber component containing at least a diene-based rubber, 0.1 to 10 parts by mass of a compound represented by the following general formula (1): 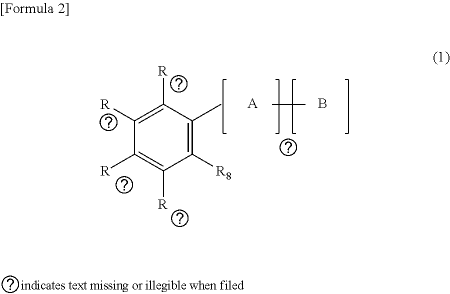
wherein at least one of R₁ to R₅ is an 'OH group or an —OCH₃ group and others are each an —H group or a hydrocarbon group having 1 to 20 carbon atoms, A is an unsaturated bond or an alkylene group having 1 to 20 carbon atoms and optionally having an —H group, a —CH₃ group, an —NH₂ group, an —O— group, or an —OH group, n is an integer of 0 to 10, and B is a —COOH group, an —OH group, or an ═O group and optionally forms a ring structure with adjacent R₁ or R₅; and 40 to 140 parts by mass of carbon black having a nitrogen adsorption specific surface area of 140 to 250 m²/g.

2. The rubber composition according to claim 1, comprising 10 to 80 parts by mass of a petroleum resin per 100 parts by mass of the rubber component.

3. The rubber composition according to claim 1, wherein the compound represented by the general formula (1) is a naturally occurring compound.

4. The rubber composition according to claim 1, wherein the compound represented by the general formula (1) is at least one of 3,4-dihydroxycinnamic acid and 3,4-dimethoxycinnamic acid.

5. A pneumatic tire comprising a rubber part containing a vulcanized rubber of the rubber composition according to claim 1.

6. A pneumatic tire for motorsports comprising a tread part containing a vulcanized rubber of the rubber composition according to claim 1.

7. A rubber composition comprising, per 100 parts by mass of a rubber component containing at least a diene-based rubber, 0.1 to 10 parts by mass of a compound having an XLogP of 0.5 or more and 10 or less; and 40 to 140 parts by mass of carbon black having a nitrogen adsorption specific surface area of 140 to 250 m²/g.

8. The rubber composition according to claim 7, comprising 10 to 80 parts by mass of a petroleum resin per 100 parts by mass of the rubber component.

9. The rubber composition according to claim 7, wherein the compound having an XLogP of 0.5 or more and 10 or less is a naturally occurring compound.

10. The rubber composition according to claim 7, wherein the compound having an XLogP of 0.5 or more and 10 or less is at least one of 3,4-dihydroxycinnamic acid and 3,4-dimethoxycinnamic acid.

11. A pneumatic tire comprising a rubber part containing a vulcanized rubber of the rubber composition according to claim 7.

12. A pneumatic tire for motorsports comprising a tread part containing a vulcanized rubber of the rubber composition according to claim 7.
